(19) United States
(12) Patent Application Publication
(10) Pub. No.: US 2015/0365371 A1
(43) Pub. Date: Dec. 17, 2015

(54) Channels: Real Time, Internet Social Networking, Multichannel, Communication and Multimedia Sharing Application

(71) Applicant: George McDowell Agnew, Tucson, AZ (US)

(72) Inventor: George McDowell Agnew, Tucson, AZ (US)

(21) Appl. No.: 14/307,403

(22) Filed: Jun. 17, 2014

(51) Int. Cl. H04L 12/58; H04L 29/08; H04L 29/06

(52) U.S. Cl. CPC H04L 51/32; H04L 65/60; H04L 67/306; H04L 67/10

(57) ABSTRACT

Examples of use to explain the unique and innovative system and process:

A group of five teenagers hiking in the woods wearing ear buds. The group administrator has created a Channels Group for the five letting everybody use the talk channel but has created a music channel from the playlist on her device. A few of the users are enjoying the music at a higher level and others have the music turned down and are more involved in a conversation. One user has a music suggestion and the administrator gives him a channel permission and he begins a song and they all dance to the music in the woods.

A group of ten students studying. A few are together but most are in different places. The administrator has created a Channels Group with talk available to all ten, and three channels of pdf text books that they're discussing. When a few people don't understand a concept, another user with administrator permission uses a drawing app to sketch out the concept in an easier way for the others to understand.

An entertainer or writer creates a Channels Group with five channels available to five friends to discuss and listen to and share, music and watch videos while inviting millions of fans observe as passive users.

Channels is a social networking internet site and app that groups people in real time to talk, share music, photos, videos and other media formats.

The application will provide each user with channels to share content. The first channel is for talking. Additional channels are for available media; music, photos, video. Each user can control the sound level or size (if applicable) to every channel.

A group is started by the first user who becomes the administrator. The administrator invites other users and gives permissions to use channels. These permissions can be complete, creating a co-administrator; to observation only becoming a passive user.

### BACKGROUND OF THE INVENTION

This is a system and process for a social network application conceived by George McDowell Agnew, June 2014.

### BRIEF SUMMARY OF THE INVENTION

A social network system that groups people in real time to communicate and share media using multiple audio, video and data channels.

### DETAILED DESCRIPTION OF THE INVENTION

Using the Application

A primary user downloads application from Channels site and creates username & password.

Primary touches New Group button and becomes the Group Administrator.

Primary is prompted to Channels Window.

Top channel (#1) is dedicated to the microphone of the device and is available by default.

This can be a text channel if a microphone is not available.

The primary user is offered a Create New Channel button. Touching button browses to applications on the device. Applications can be recorded music on device, pdf readers, photo & video players or any data stream available on the device. Once the application opens the other users will be able see and hear but not interact unless enabled by the primary user and application designer.

Primary can create multiple channels. Active channels and content are displayed in an Active Channels window.

Primary enters a real time start for the Channels Group, immediately or scheduled.

Primary touches Invite button and the application and device contact lists can be browsed for invitee usernames/emails. Primary sets permissions for each user's involvement in the group. This can be complete letting the user act as a co-administrator. Primary can allow other users to create additional channels.

Event begins when scheduled.

This is an unique real time social networking system and process presented as an application that uses available internet technology to share and interact with audio, image and data information for a group of people by using multiple channels available to the group.

What is claimed:

1. A social networking system using internet connected devices, presented as an application, to let a group of people, in a real time event, share and interact with audio, video, image and data applications, by using multiple channels to present those applications to the group.

2. A method in claim 1 wherein the person or entity begins a group (Group), and administrates the Group, (Administrator) for an event, (Group Event)

3. A method in claim 1 wherein the application creates a first channel for the microphone of a device creating a communication channel between devices. This can be a text channel if a microphone is not available or wanted.

4. A method in claim 1 wherein the administrator creates a new channel by opening an audio, video, image or data application, within the Channels program. Administrator can open multiple applications for channels.

5. A method in claim 1 wherein the Administrator invites others into the Group, (Invitee(s)) and gives permissions to each Invitee's interaction with the open channels.

6. A method in claim 1 wherein the Administrator sets a time and date for the Channels Group Event, immediately or at a future time.

7. A method in claim 1 wherein the Administrator can add Invitees and set permissions during the Group Event.

8. A method in claim 1 wherein channels and their content are displayed in an Active Channels Window. Invitees can control the sound level or size (if applicable) to every channel.

9. A method in claim 1 wherein Invitees will be able observe applications from other devices and control as described in claim 8, but not interact unless enabled by Administrator and application designer.

10. The method in claim 1 wherein the Administrator can give Invitees permission to add channels to the group.

11. The use of the name Channels as a trademark for a social media application.
